(19) United States
(12) Patent Application Publication
(10) Pub. No.: US 2026/0209549 A1
(43) Pub. Date: Jul. 23, 2026

(54) COMPOSITE COATING, PREPARATION METHOD AND DEVICE

(71) Applicant: JIANGSU FAVORED NANOTECHNOLOGY CO., LTD., Wuxi, Jiangsu (CN)

(72) Inventors: Jian ZONG, Wuxi (CN); Yongqi TAO, Wuxi (CN)

(73) Assignee: JIANGSU FAVORED NANOTECHNOLOGY CO., LTD., Wuxi, JS (CN)

(21) Appl. No.: 19/140,880

(22) PCT Filed: Dec. 7, 2023
(86) PCT No.: PCT/CN2023/136960

§ 371 Date: Jun. 18, 2025

(30) Foreign Application Priority Data
Dec. 22, 2022 (CN) 202211657165.7

(51) Int. Cl. C09D 183/04; C09D 4/00; C09D 133/16

(52) U.S. Cl. CPC C09D 183/04; C09D 4/00; C09D 133/16

(57) ABSTRACT

A composite coating, a preparation method and a device. The composite coating comprises a coating I and a coating II, wherein the coating I is formed by means of the plasma polymerization deposition of an active functional group having affinity or reactivity with a polymer molecule, and a silane monomer of a hydrolysable group of a halogen atom, alkoxy or acyloxy, and the coating II is formed by the vacuum vapor deposition of Parylene on the coating I. the composite coating improves the binding force and use range of a Parylene coating and a base material.

### CROSS-REFERENCE TO RELATED APPLICATIONS

This application claims the benefit of priority to Chinese Patent Application No. 202211657165.7, filed on Dec. 22, 2022 with China National Intellectual Property Administration, and entitled “COMPOSITE COATING, PREPARATION METHOD AND DEVICE”, the entire disclosure of which is incorporated herein by reference.

### TECHNICAL FIELD

The present disclosure relates to the field of vacuum vapor deposition, and particularly, to a composite coating, a preparation method and a device.

### BACKGROUND

Parylene, also named as poly-p-xylene, is a new type of conformal coating material developed and applied as a protective polymer material by Union Carbide Co. of the United States in the mid-1960s, and may be classified into various types, such as, N-type, C-type, D-type, F-type, HT type, and the like, according to different molecular structures. Parylene can suffer vapor deposition under vacuum. Active molecules of parylene having good penetrating power may form a transparent insulating coating without pinholes and with a uniform thickness inside, at a bottom of, and around an electronic component, to provide a complete high-quality protective coating for the component against acids and alkalis, salt spray, mold and various corrosive gases. However, range of surface energy of this coating is relatively simple due to characteristics of molecular structure types thereof. In addition, this coating is prepared by deposition on a surface of a substrate at a low temperature after high temperature pyrolysis, and binds to the substrate by mainly an intermolecular van der Waals force but not a chemical bond formed between the coating and the substrate, and thus, a binding force between the coating and the substrate is weak. These both greatly limit application scenarios of the coating.

### SUMMARY

Embodiments of the present disclosure provide a composite coating composed with a PECVD coating to improve a binding force to a substrate and an application range thereof, a preparation method and a device.

The composite coating includes a coating I and a coating II;
the coating I is a plasma polymeric coating formed by contact of a substrate with plasma containing a monomer α, and the monomer α has a structure represented by formula (1),

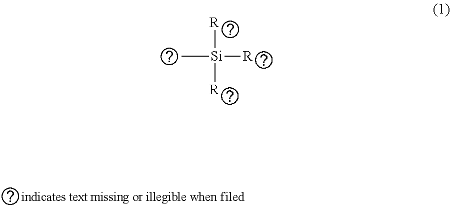

in formula (1), R₁ is a vinyl group or a substituted C₁-C₁₀ alkyl group, a substituent for the substituted C₁-C₁₀ alkyl group may include at least one selected from a group consisting of halogen atoms, alkenyl groups, alkynyl groups, hydrocarbyloxy groups, amino groups, epoxy groups, acyloxy groups, amide groups, hydroxyl groups and sulfhydryl groups, and R₂, R₃ and R₄ are each independently selected from a group consisting of halogen atoms, C₁-C₁₀ alkoxy groups, substituted C₁-C₁₀ alkoxy groups, C₁-C₁₀ acyloxy groups and substituted C₁-C₁₀ acyloxy groups; and
the coating II is a parylene coating formed by vacuum vapor deposition on the coating I.

In some embodiments, R₁ is a vinyl group, a glycidyloxypropyl group, an acryloyloxypropyl group, a methacryloyloxypropyl group, a N-(β-aminoethyl)-γ-aminopropyl group, a N-(β-aminoethyl)-γ-aminopropyl-methyl group, a chloropropyl group, a mercaptopropyl group, a hydroxypropyl group or an aminopropyl group, and R₂, R₃ and R₄ are each independently a chlorine atom, a methoxy group, an ethoxy group or a methoxyethoxy group.

In some embodiments, the monomer α is at least one selected from a group consisting of vinyl trichlorosilane, vinyl trimethoxysilane, vinyl triethoxysilane, vinyl tri(β-methoxyethoxy)silane, γ-glycidyloxypropyl-trimetboxysilane, γ-glycidyloxypropyl-triethoxysilane, 3-(acryloyloxy)propyltrimethoxysilane, γ-methacryloyloxypropyl-trimethoxysilane, γ-methacryloyloxypropyl-triethoxysilane, N-(β-aminoethyl)-γ-aminopropyl-methyl-trimethoxysilane, N-(β-aminoethyl)-γ-aminopropyl-methyl-triethoxysilane, N-(β-aminoethyl)-γ-aminopropyl-trimethoxysilane, N-(β-aminoethyl)-γ-aminopropyl-triethoxysilane, γ-chloropropyl-trimethoxysilane, γ-chloropropyl-triethoxysilane, γ-mercaptopropyl-trimethoxysilane, γ-mercaptopropyl-triethoxysilane, γ-aminopropyl-trimethoxysilane and γ-aminopropyl-triethoxysilane.

In some embodiments, the monomer α is γ-aminopropyl-triethoxysilane.

In some embodiments, the composite coating further includes a coating III. The coating III is a hydrophobic or hydrophilic plasma polymeric coating formed by contact of the coating II with plasma containing a monomer β.

In some embodiments, the monomer β has a structure represented by formula (2),

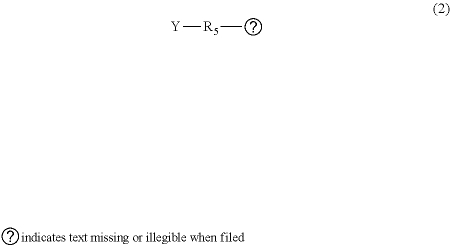

in formula (2), R₅ is a linking bond, a C₁-C₄ alkylidene group or a halogenated C₁-C₄ alkylidene group, Y is a halogen atom, a hydrogen atom, a hydroxyl group, or a structure represented by formula (3) or (4), and n is an integer from 1 to 12,

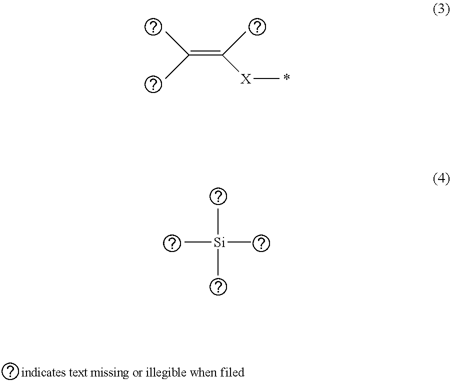

in formula (3), R₆, R₇ and R₅ are each independently selected from a group consisting of a hydrogen atom, halogen atoms, C₁-C₄ alkyl groups and halogenated C₁-C₄ alkyl groups, and X is a linking bond or an ester bond, and

in formula (4), R₉, R₁₀ and R₁₁ are each independently selected from a group consisting of a hydrogen atom, C₁-C₄ alkyl groups, halogenated C₁-C₄ alkyl groups, C₁-C₄ alkoxy groups and halogenated C₁-C₄ alkoxy groups.

In some embodiments, the monomer β has a structure represented by formula (5),

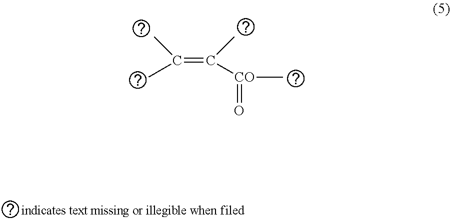

in formula (5), m is an integer from 0 to 4.

In some embodiments, R₆, R₇ and R₈ are each independently selected from a group consisting of a hydrogen atom and a methyl group, m is an integer from 0 to 2, and n is an integer from 1 to 10.

In some embodiments, the monomer β is 2-perfluorohexylethyl acrylate.

In some embodiments, the monomer β has a structure represented by formula (6),

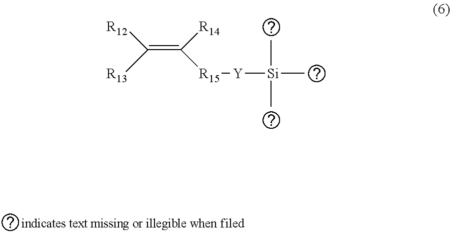

in formula (6), R₁₂, R₁₃ and R₁₄ are each independently selected from a group consisting of a hydrogen atom, halogen atoms, C₁-C₄ alkyl groups or halogenated C₁-C₄ alkyl groups, R₁₅ is a linking bond, a C₁-C₄ alkylidene group or a halogenated C₁-C₄ alkylidene group, R₁₆, R₁₇ and R₁₈ are each independently selected from a group consisting of a hydrogen atom, C₁-C₄ alkyl groups, halogenated C₁-C₄ alkyl groups, C₁-C₄ alkoxy groups or halogenated C₁-C₄ alkoxy groups, and Y is a linking bond or an oxygen atom.

In some embodiments, the monomer β has a structure represented by formula (7),

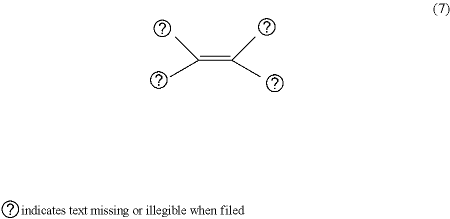

in formula (7), R₁₉ is a C₁-C₄ amide group, a substituted C₁-C₄ alkoxy group, a substituted C₁-C₄ alkyl group or a substituted C₁-C₄ ester group, and R₂₀, R₂₁ and R₂₂ are each independently selected from a group consisting of a hydrogen atom, C₁-C₄ amide groups, substituted C₁-C₄ alkoxy groups, substituted C₁-C₄ alkyl groups, substituted C₁-C₄ ester groups and C₁-C₄ hydrocarbyl groups; and
a substituent for each of the substituted C₁-C₄ alkoxy groups, substituted C₁-C₄ alkyl groups and substituted C₁-C₄ ester groups is a hydroxyl group, a carboxyl group or an amino group.

In some embodiments, R₁₉ is a C₁-C₄ hydroxyalkyl ester group, and R₂₀, R₂₁ and R₂₂ are each independently selected from a group consisting of a hydrogen atom and a methyl group.

In some embodiments, the monomer β is at least one selected from a group consisting of acrylic acid, methacrylic acid, 3,3-dimethacrylic acid, hydroxyethyl acrylate, hydroxypropyl acrylate, hydroxyethyl methacrylate, 1-buten-3-ol, 1,4-butanediol, 3-penten-2-ol, cis-3-hexen-1-ol, methallyl alcohol, 2,7-octadien-1-ol, N-tert-butylacrylamide, glycerol dimethacrylate, N,N-diethylaminoethyl acrylate, dimethylaminoethyl methacrylate and N, N-dimethylacrylamide.

In some embodiments, the coating III is a hydrophobic or hydrophilic plasma polymeric coating formed by contact of the coating II with plasma containing the monomer β and a monomer δ, and the monomer δ has a structure represented by formula (8),

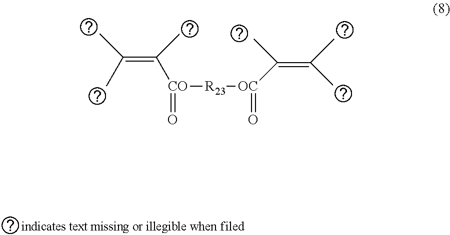

in formula (8), R₂₄, R₂₅, R₂₆, R₂₇, R₂₈ and R₂₉ are each independently selected from a group consisting of a hydrogen atom, C₁-C₁₀ alkyl groups or halogenated C₁-C₁₀ alkyl groups, and R₂₃ is a linker.

In some embodiments, the monomer δ has a structure represented by formula (9),

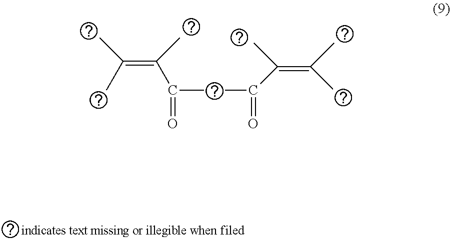

in formula (9), R₃₀ is a C₂-C₁₀ alkylidene group or a halogenated C₂-C₁₀ alkylidene group, and a is an integer from 1 to 10.

In some embodiments, R₂₄, R₂₅, R₂₆, R₂₇, R₂₈ and R₂₉ are each independently selected from a group consisting of a hydrogen atom and a methyl group, and a is an integer from 1 to 4.

In some embodiments, the monomer δ is at least one selected from a group consisting of 1,4-butanediol dimethacrylate, 1,6-hexanediol dimethacrylate, ethylene glycol dimethacrylate, diethylene glycol dimethacrylate, triethylene glycol dimethacrylate, tetraethylene glycol dimethacrylate, 1,3-butanediol dimethacrylate and neopentyl glycol dimethacrylate.

The embodiments of the present disclosure further provide a method for preparing the composite coating as described above. The method includes the following steps.

Providing a substrate and placing the substrate in a vacuum deposition cavity, introducing the monomer α in gaseous form into the vacuum deposition cavity, and performing plasma discharge, to form the coating I by plasma polymerization on a surface of the substrate; and

Introducing sublimated and pyrolyzed parylene powder into the vacuum deposition cavity, to form the coating II on the coating I.

In some embodiments, the method further includes introducing the monomer β in gaseous form, or introducing the monomer β and the monomer δ in gaseous form, into the vacuum deposition cavity, and performing plasma discharge, to form the coating III on a surface of the coating II by plasma polymerization.

The embodiments of the present disclosure further provide a device. The device has at least a part of a surface thereof coated by the composite coating as described above.

The composite coating of the embodiments of the present disclosure includes the coating I and the coating II. the coating I is formed by plasma polymerization and deposition of a silane monomer containing an active functional group that has affinity or reactivity with a polymer molecule and containing a hydrolyzable group, such as, a halogen atom, an alkoxy group or acyloxy group. The coating II is formed by vacuum vapor deposition of parylene on the coating I. The composite coating improves the binding force between parylene and the substrate and application range of parylene.

### DETAILED DESCRIPTION

The embodiments of the present disclosure provide a composite coating. The composite coating includes a coating I and a coating II.

The coating I is a plasma polymeric coating formed by contact of a substrate with plasma containing a monomer α, and the monomer α has a structure represented by formula (1),

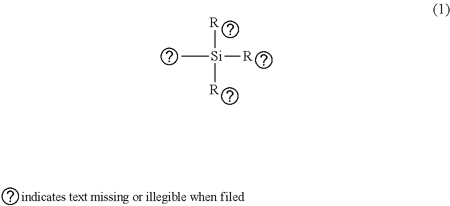

in formula (1), R₁ is a vinyl group or a substituted C₁-C₁₀ alkyl group, a substituent for the substituted C₁-C₁₀ alkyl group may include at least one selected from a group consisting of halogen atoms, alkenyl groups, alkynyl groups, hydrocarbyloxy groups, amino groups, epoxy groups, acyloxy groups, amide groups, hydroxyl groups and sulfhydryl groups, and R₂, R₃ and R₄ are each independently selected from a group consisting of halogen atoms, C₁-C₁₀ alkoxy groups, substituted C₁-C₁₀ alkoxy groups, C₁-C₁₀ acyloxy groups and substituted C₁-C₁₀ acyloxy groups.

The coating II is a parylene coating formed by vacuum vapor deposition on the coating I.

R₁ is a substituted C₁-C₁₀ alkyl group refers to R₁ is a C₁-C₁₀ alkyl group with a substituent. The substituent is an active group, such as, a halogen atom, an alkenyl group, an alkynyl group, a hydrocarbyloxy group, an amino group, an epoxy group, an acyloxy group, an amide group, a hydroxyl group or a sulfhydryl group. The active group has affinity or reactivity with a polymer molecule. In some embodiments, R₁ is a vinyl group, a glycidyloxypropyl group, an acryloyloxypropyl group, a methacryloyloxypropyl group, a N-(β-aminoethyl)-γ-aminopropyl group, a N-(β-aminoethyl)-γ-aminopropyl-methyl group, a chloropropyl group, a mercaptopropyl group, a hydroxypropyl group or an aminopropyl group.

R₂, R₃ and R₄ are each independently selected from a group consisting of hydrolyzable groups, such as, halogen atoms, C₁-C₁₀ alkoxy groups, substituted C₁-C₁₀ alkoxy groups, C₁-C₁₀ acyloxy groups and substituted C₁-C₁₀ acyloxy groups. The substituted C₁-C₁₀ alkoxy groups and the substituted C₁-C₁₀ acyloxy groups refer to C₁-C₁₀ alkoxy groups with a substituent and C₁-C₁₀ acyloxy groups with a substituent. The substituent may be a halogen atom or various organic groups, such as a hydrocarbyl group, a hydrocarbyloxy group, an ester group or a ketone group, and the like. In some embodiments, R₂, R₃ and R₄ are each independently selected from a group consisting of halogen atoms, C₁-C₄ alkoxy groups and C₁-C₄ acyloxy groups. In some embodiments, R₂, R₃ and R₄ are each independently a chlorine atom, a methoxy group, an ethoxy group or a methoxyethoxy group.

In some embodiments, the monomer α is at least one selected from a group consisting of vinyl trichlorosilane, vinyl trimethoxysilane, vinyl triethoxysilane, vinyl tri(β-methoxyethoxy)silane, γ-glycidyloxypropyl-trimethoxysilane, γ-glycidyloxypropyl-triethoxysilane, 3-(acryloyloxy) propyltrimethoxysilane, γ-methacryloyloxypropyl-trimethoxysilane, γ-methacryloyloxypropyl-triethoxysilane, N-(β-aminoethyl)-γ-aminopropyl-methyl-trimethoxysilane, N-(β-aminoethyl)-γ-aminopropyl-methyl-triethoxysilane, N-(β-aminoethyl)-γ-aminopropyl-trimethoxysilane, N-(β-aminoethyl)-γ-aminopropyl-triethoxysilane, γ-chloropropyl-trimethoxysilane, γ-chloropropyl-triethoxysilane, γ-mercaptopropyl-trimethoxysilane, γ-mercaptopropyl-triethoxysilane, γ-aminopropyl-trimethoxysilane and γ-aminopropyl-triethoxysilane. In some embodiments, the monomer α is γ-aminopropyl-triethoxysilane.

The parylene coating of the composite coating according to the embodiments of the present disclosure includes a coating formed by vacuum vapor deposition of N-type parylene, C-type parylene, D-type parylene, F-type parylene or HT-type parylene.

In some embodiments, the composite coating further includes coating III. In some embodiments, the coating III is a hydrophobic plasma polymeric coating formed by contact of the coating II with plasma containing a monomer β. The monomer β has a structure containing a perfluorinated segment represented by formula (2),

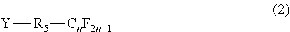

in formula (2), R₅ is a linking bond, a C₁-C₄ alkylidene group or a halogenated C₁-C₄ alkylidene group, Y is a halogen atom, a hydrogen atom, a hydroxyl group, or a structure represented by formula (3) or (4), and n is an integer from 1 to 12, and specifically, 1, 2, 3, 4, 5, 6, 7, 8, 9, 10, 11 or 12.

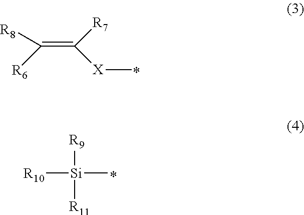

in formula (3), R₆, R₇ and R₈ are each independently selected from a group consisting of a hydrogen atom, halogen atoms, C₁-C₄ alkyl groups or halogenated C₁-C₄ alkyl groups, and X is a linking bond or an ester bond. In some embodiments, R₆, R₇ and R₈ are each independently selected from a group consisting of a hydrogen atom or a methyl group. In some embodiments, R₆ and R₈ are each a hydrogen atom, and R₇ is a hydrogen atom or a methyl group. In formula (4), R₉, R₁₀ and R₁₁ are each independently selected from a group consisting of a hydrogen atom, C₁-C₄ alkyl groups, halogenated C₁-C₄ alkyl groups, C₁-C₄ alkoxy groups and halogenated C₁-C₄ alkoxy groups. The C₁-C₄ alkylidene groups may be specifically, for example, methylene, ethylidene, propylidene, butylidene or isobutylidene, and the like. The C₁-C₄ alkyl groups may be specifically, for example, methyl, ethyl, propyl, butyl or isobutyl, and the like. The C₁-C₄ alkoxy groups may be specifically, for example, methoxy, ethoxy, propoxy, butoxy or isobutoxy, and the like. The halogenated means that at least one hydrogen atom on a carbon chain is substituted by a halogen atom.

In some embodiments, the monomer β has a structure represented by formula (5),

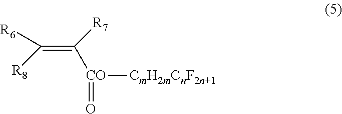

in formula (5), m is an integer from 0 to 4, and specifically, 0, 1, 2, 3 or 4. In some embodiments, in consideration of influence on the environment, n is an integer from 1 to 10, and further, n is an integer from 1 to 7. In some embodiments, the monomer β is one or more selected from a group consisting of 2-perfluorodecylethyl methacrylate, 2-perfluorohexylethyl methacrylate, 2-perfluorododecyl ethyl acrylate, 2-perfluorooctyl ethyl acrylate, 1H,1H,2H,2H-perfluorooctylacrylate and 2-perfluorobutylethyl acrylate. In some embodiments, the monomer β is 2-perfluorohexylethyl acrylate.

In some embodiments, the monomer β has a structure represented by formula (6),

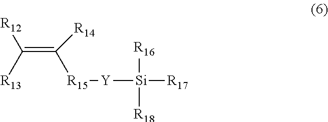

in formula (6), R₁₂, R₁₃ and R₁₄ are each independently selected from a group consisting of a hydrogen atom, halogen atoms, C₁-C₄ alkyl groups or halogenated C₁-C₄ alkyl groups, R₁₅ is a linking bond, a C₁-C₄ alkylidene group or a halogenated C₁-C₄ alkylidene group, R₁₆, R₁₇ and R₁₈ are each independently selected from a group consisting of a hydrogen atom, C₁-C₄ alkyl groups, halogenated C₁-C₄ alkyl groups, C₁-C₄ alkoxy groups or halogenated C₁-C₄ alkoxy groups, and Y is a linking bond or an oxygen atom. The C₁-C₄ alkylidene group may be specifically, for example, methylene, ethylidene, propylidene, butylidene or isobutylidene, and the like. The C₁-C₄ alkyl groups may be specifically, for example, methyl, ethyl, propyl, butyl or isobutyl, and the like. The C₁-C₄ alkoxy groups may be specifically, for example, methoxy, ethoxy, propoxy, butoxy or isobutoxy, and the like. The halogenated means that at least one hydrogen atom on a carbon chain is substituted by a halogen atom.

In some embodiments, the coating III is a hydrophilic plasma polymeric coating formed by contact of the coating II with plasma containing the monomer β. In some embodiments, the monomer β has a structure represented by formula (7),

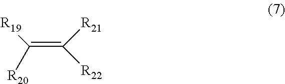

in formula (7), R₁₉ is a C₁-C₄ amide group, a substituted C₁-C₄ alkoxy group, a substituted C₁-C₄ alkyl group or a substituted C₁-C₄ ester group, and R₂₀, R₂₁ and R₂₂ are each independently selected from a group consisting of a hydrogen atom, C₁-C₄ amide groups, substituted C₁-C₄ alkoxy groups, substituted C₁-C₄ alkyl groups, substituted C₁-C₄ ester groups and C₁-C₄ hydrocarbyl groups. A substituent for each of the substituted C₁-C₄ alkoxy groups, substituted C₁-C₄ alkyl groups and substituted C₁-C₄ ester groups is a hydroxyl group, a carboxyl group or an amino group or other hydrophilic groups. The substituted C₁-C₄ alkoxy groups, the substituted C₁-C₄ alkyl groups or the substituted C₁-C₄ ester groups refer to C₁-C₄ alkoxy groups, C₁-C₄ alkyl groups or C₁-C₄ ester groups with a substituent of a hydroxyl group, a carboxyl group or an amino group. In some embodiments, the monomer β is acrylic acid, methacrylic acid, 3,3-dimethacrylic acid, 1,4-butanediol, 3-penten-2-ol, cis-3-hexen-1-ol, methallyl alcohol, 2,7-octadiene-1-ol, N-tert-butylacrylamide, glycerol dimethacrylate, N,N-diethylaminoethyl acrylate, dimethylaminoethyl methacrylate or N,N-dimethacrylamide. In some embodiments, R₁₉ is a C₁-C₄ hydroxyalkyl ester group, such as, a hydroxymethyl ester group, a hydroxyethyl ester group, a hydroxypropyl ester group or a hydroxybutyl ester group, and R₂₀, R₂₁ and R₂₂ are each independently selected from a group consisting of a hydrogen atom or a methyl group. In some embodiments, R₂₀ is a hydrogen atom or a methyl group, and R₂₁ and R₂₂ are each a hydrogen atom. In some embodiments, the monomer β is hydroxyethyl acrylate, hydroxypropyl acrylate or hydroxyethyl methacrylate.

In some embodiments, the coating III is a hydrophobic or hydrophilic plasma polymeric coating formed by contact of the coating II with plasma containing the monomer β and a monomer δ, and the monomer δ has a structure represented by formula (8),

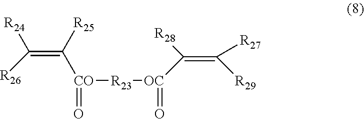

in formula (8), R₂₄, R₂₅, R₂₆, R₂₇, R₂₈ and R₂₉ are each independently selected from a group consisting of a hydrogen atom, C₁-C₁₀ alkyl groups or halogenated C₁-C₁₀ alkyl groups, and R₂₃ is a linker. In some embodiments. R₂₄, R₂₅, R₂₆, R₂₇, R₂₈ and R₂₉ are each independently selected from a group consisting of a hydrogen atom, C₁-C₄ alkyl groups or halogenated C₁-C₄ alkyl groups. In some embodiments, R₂₄, R₂₅, R₂₆, R₂₇, R₂₈ and R₂₉ are each independently selected from a group consisting of a hydrogen atom and a methyl group. In some embodiments, R₂₅ and R₂₈ are each a hydrogen atom or a methyl group, and R₂₄, R₂₆, R₂₇ and R₂₉ are each a hydrogen atom. R₂₃ is a linker, and may be, for example, an alkylidene group, a substituted alkylidene group, an alkylidene group with an O or S atom or a carbonyl group between a carbon-carbon linking bond, and the like. A substituent for the substituted alkylidene group may be various organic groups, and specifically, for example, a halogen atom, a hydroxyl group, a hydroxyl alkyl group, an aryl group, an ester group, a hydrocarbyloxy group, a ketone group, and the like. In some embodiments, the monomer δ has a structure represented by formula (9),

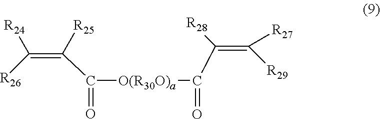

in formula (9), R₃₀ is a C₂-C₁₀ alkylidene group or a halogenated C₂-C₁₀ alkylidene group, and a is an integer from 1 to 10, and specifically, 1, 2, 3, 4, 5, 6, 7, 8, 9 or 10. The alkylidene group may be specifically, for example, methylene, ethylidene, propylidene, butylidene or isobutylidene, and the like. In some embodiments, a is an integer from 1 to 4. In some embodiments, the monomer δ is at least one selected from a group consisting of 1,4-butanediol dimethacrylate, 1,6-hexanediol dimethacrylate, ethylene glycol dimethacrylate, diethylene glycol dimethacrylate, triethylene glycol dimethacrylate, tetraethylene glycol dimethacrylate, 1,3-butanediol dimethacrylate and neopentyl glycol dimethacrylate.

In some embodiments, the coating I is a plasma polymeric coating formed from plasma of the monomer α. In some other embodiments, the coating I may be a plasma polymeric coating formed from plasma of the monomer α together with appropriate other monomers, without affecting overall coating performance of the coating I. In some embodiments, the coating III is a plasma polymeric coating formed by contact of the coating II with plasma of the monomer β. In some embodiments, the coating III is a plasma polymeric coating formed by contact of the coating II with plasma of the monomer β and the monomer δ. In some other embodiments, the coating III is formed from plasma where appropriate other monomers are added, without affecting overall coating performance of the coating III.

In some embodiments, a molar ratio of the monomer β to the monomer δ is between 3:10~10:3, and may specifically be, for example, 3:10, 4:10, 5:10, 6:10, 7:10, 8:10, 9:10, 10:10, 10:9, 10:8, 10:7, 10:6, 10:5, 10:4 or 10:3 and the like. In some other embodiments, in the case of both satisfactory protection performance and transparency, the molar ratio may be adjusted between other ratios according to specific monomers.

In some embodiments, the substrate is a variety of plastics, metals, fabrics, glass, electrical components or optical instruments, and the like. Specifically, the electrical components may be printed circuit boards (PCBs), electronic products or semi-finished electronic assembly products, and the like. When the substrate is an electronic product, it is exemplarily, but not limited to, mobile phones, tablets, keyboards, e-readers, wearable devices, displays, and the like. The substrate may also be any suitable electrical part of the electrical components. Specifically, the electrical part may be a sensor, a resistor, a capacitor, a transistor, a diode, an amplifier, a relay, a transformer, a battery, a fuse, an integrated circuit, a switch, an LED, an LED display, a piezoelectric element, an optoelectronic component, or an antenna or an oscillator, and the like.

In some embodiments, the substrate is a substrate that has undergone surface treatment, such as, plasma surface treatment, thermal oxygen surface treatment, coating with other coatings, and the like.

The embodiments of the present disclosure further provide a method for preparing the composite coating above. The method includes the following steps: providing a substrate and placing the substrate in a vacuum deposition cavity, introducing the monomer α in gaseous form into the vacuum deposition cavity, and performing plasma discharge, to form the coating I by plasma polymerization on a surface of the substrate; and introducing sublimated and pyrolyzed parylene powder into the vacuum deposition cavity, to form the coating II on the coating I.

In some embodiments, the method further includes: placing the substrate with the coating I and the coating II in the vacuum deposition cavity, introducing the monomer β in gaseous form, or introducing the monomer β and the monomer δ in gaseous form, into the vacuum deposition cavity, and performing plasma discharge, to form the coating III on a surface of the coating II by plasma polymerization.

In the method for preparing the composite coating according to the embodiments of the present disclosure, a vacuum deposition process for parylene may be a general parylene vacuum deposition process. That is, a parylene powdered material is placed in a evaporation furnace of a coating equipment, sublimated from a solid raw material into gaseous state under vacuum at a high temperature of 80° C.~200° C., and then pyrolyzed from a gaseous raw material into a reactive monomer by pyrolysis at a high temperature of 600° C.~750° C., and the gaseous monomer is deposited and polymerizes at room temperature to form the coating II of parylene.

In the method for preparing the composite coating according to the embodiments of the present disclosure, description of the monomer α, the monomer β, the monomer δ, material of parylene and the substrate are as described above.

In the method for preparing the composite coating according to the embodiments of the present disclosure, in order to further increase the binding force between the plasma polymeric coating and the substrate, in some embodiments, the substrate is pretreated with plasma before coating. Specifically, pretreatment may be carried out by, for example, continuous discharge pretreatment in an inert gas atmosphere, with a discharge power of 100 W~600 W, for a discharge time of 60 seconds~3600 seconds, or pulse discharge pretreatment, with a pulse duty cycle of 0.1%~70%, at a pulse frequency of 10 Hz~500 Hz, with a discharge power of 10 W~500 W, for a discharge time of 60 seconds~3600 seconds. In some other embodiments, the substrate is pretreated with heat, oxygen or high-energy radiation and other means before coating.

In some embodiments, a flow rate of the monomer α, the monomer β, the monomer δ or a mixed monomer of the monomer β and the monomer δ is 10 ul/min-2400 ul/min, and may specifically be, for example, 10 ul/min, 50 ul/min, 100 ul/min, 200 ul/min, 300 ul/min, 500 ul/min, 1000 ul/min, 1500 ul/min, 2000 ul/min or 2400 ul/min, and the like. The chamber may has a temperature controlled at 20° C.-80° C., and specifically at, for example, 20° C., 30° C., 40° C., 50° C., 60° C., 70° C. or 80° C., and the like. The monomers may be gasified at a temperature of 50° C.-120° C., and specifically at, for example, 50° C., 60° C., 70° C., 80° C., 90° C., 100° C., 110° C. or 120° C., and the like, under a vacuum condition.

In some embodiments, the plasma is continuous plasma produced by applying continuous voltage discharge with a discharge power of 10 W~300 W, and specifically of, for example, 10 W, 50 W, 100 W, 150 W, 200 W, 250 W or 300 W, for a discharge time of 60 seconds~36000 seconds, and specifically of, for example, 60 seconds, 100 seconds, 200 seconds, 300 seconds, 400 seconds, 500 seconds, 600 seconds, 1000 seconds, 2000 seconds, 3600 seconds, 5000 seconds, 10000 seconds, 20000 seconds or 36000 seconds, and the like. In some embodiments, the plasma is pulsed plasma produced by applying pulse voltage discharge with a pulse power of 10 W-500 W, and specifically of, for example, 10 W, 50 W, 100 W, 150 w, 200 w, 250 w, 300 w, 350 w, 400 w, 450 w or 500 w, and the like, at a pulse frequency of 10 Hz-500 Hz, and specifically of, for example, 10 Hz, 15 Hz, 20 Hz, 25 Hz, 30 Hz, 35 Hz, 40 Hz, 45 Hz, 50 Hz, 100 Hz, 200 Hz, 300 Hz, 400 Hz or 500 Hz, and the like, with a pulse duty cycle of 0.1%~90%, and specifically of, for example, 0.1%, 0.5%, 1%, 5%, 10%, 15%, 20%, 25%, 30%, 35%, 40%, 45%, 50%, 55%, 60%, 65%, 70%, 75%, 80%, 85% or 90%, and the like, for a plasma discharge time of 200 seconds-36000 seconds, and specifically of, for example, 200 seconds, 500 seconds, 1000 seconds, 2000 seconds, 3600 seconds, 5000 seconds, 10000 seconds, 20000 seconds or 36000 seconds, and the like.

In some embodiments, mode of plasma discharge may be various existing discharge modes, and may specifically be, for example, electrodeless discharge (such as radio frequency inductive coupling discharge, microwave discharge), single electrode discharge (such as corona discharge, plasma jet formed by unipolar discharge), double electrode discharge (such as dielectric barrier discharge, radio frequency glow discharge with bare electrode), and multi-electrode discharge (such as discharge with a floating electrode as a third electrode).

The embodiments of the present disclosure further provide a device. The device has at least a part of a surface thereof coated by the composite coating as described above. In some embodiments, part or all of the surface of the device is deposited with the composite coating as described above.

The present disclosure is further explained below through specific examples.

### EXAMPLES

### Description of Test Methods

Coating thickness was tested with American Filmetrics F20-UV-film thickness measuring instrument.

Hydrophobic angle was tested according to GB/T 30447-2013 standard.

20.5V acid sweat soaking power-on: 1. 20.5V voltage was provided by a power supply for a circuit board; 2. the circuit board was soaked in acid artificial sweat with pH of 4.7±0.1; 3. current was detected using a computer; and 4. a failure time (current>0.6 mA) was recorded.

A binding force with a black ink plate was tested according to ASTM D3359-2017 Standard Test Method Tape Method for adhesion.

### Example 1

Parylene C powder and a 3-aminopropyl triethoxysilane monomer were loaded into their respective feeding areas. A silicon wafer, a printed circuit board and a black ink plate sample were placed on a rotating bracket in a vacuum deposition cavity, followed by rotating the rotating bracket. And then, the cavity was evacuated to 10 mTorr, and introduced with helium gas at a flow rate of 40 sccm, under a pressure stably controlled at 80 mTorr, at a cavity temperature of 30° C.

Plasma continuous discharge was turned on for pretreatment, with a discharge power of 180 W, for a continuous discharge time of 300 seconds, to carry out surface pretreatment for the silicon wafer, the printed circuit board and the black ink plate sample. And then, the discharge was ended when the pretreatment was completed.

Thereafter, the 3-aminopropyl triethoxysilane monomer was introduced into a gasification chamber at a flow rate of 480 μL/min, gasified at a gasification temperature of 90° C., and then, introduced into the cavity. Subsequently, pulse plasma discharge was turned on, to carry out plasma chemical vapor deposition, with a pulse duty cycle of 8%, at a pulse frequency of 50 Hz, with a pulse discharge power of 200 W, for a reaction time of 600 seconds.

The discharge was ended, the monomer and helium feed was turned off, the pressure in the cavity was controlled to 20 mTorr. Then, the parylene C powder was heated in a sublimation chamber to 170° C. and sublimated, entered a pyrolysis chamber and pyrolyzed at a temperature of 690° C., and then introduced into the cavity and deposited, for a deposition time of 4 h. Raw materials that were not deposited were adsorbed through a cold trap to prevent them from entering a vacuum pump.

After the coating was completed, the cavity was filled with compressed air to restore the normal pressure, and the coated silicon wafer, printed circuit board and black ink plate sample were taken out. The silicon wafer was tested for coating thickness and water contact angle at each of points taken from three layers of A, B and C from top to bottom in the bracket, and test results are listed in Table 1. The printed circuit board was tested for 20.5 V acid sweat soaking power-on at each of points taken from three layers of A, B and C from top to bottom in the bracket, and test results are listed in Table 1. The black ink plate sample was tested for the binding force at each of points taken from three layers of A, B and C from top to bottom in the bracket, and test results are listed in Table 1.

### Example 2

Parylene C powder and a 3-aminopropyl triethoxysilane monomer were loaded into their respective feeding areas. A silicon wafer, a printed circuit board and a black ink plate sample were placed on a rotating bracket in a vacuum deposition cavity, followed by rotating the rotating bracket. And then, the cavity was evacuated to 10 mTorr, and introduced with helium gas at a flow rate of 40 sccm, under a pressure stably controlled at 80 mTorr, at a cavity temperature of 30° C.

Plasma continuous discharge was turned on for pretreatment, with a discharge power of 180 W, for a continuous discharge time of 300 seconds, to carry out surface pretreatment for the silicon wafer, the printed circuit board and the black ink plate sample. And then, the discharge was ended when the pretreatment was completed.

Thereafter, the 3-aminopropyl triethoxysilane monomer was introduced into a gasification chamber at a flow rate of 480 μL/min, gasified at a gasification temperature of 90° C., and then, introduced into the cavity. Subsequently, pulse plasma discharge was turned on, to carry out plasma chemical vapor deposition, with a pulse duty cycle of 8%, at a pulse frequency of 50 Hz, with a pulse discharge power of 200 W, for a reaction time of 600 seconds.

The discharge was ended, the monomer and helium feed was turned off, the pressure in the cavity was controlled to 20 mTorr. Then, the parylene C powder was heated in a sublimation chamber to 170° C. and sublimated, entered a pyrolysis chamber and pyrolyzed at a temperature of 690° C., and then introduced into the cavity and deposited, for a deposition time of 4 h. Raw materials that were not deposited were adsorbed through a cold trap to prevent them from entering a vacuum pump.

Then, a valve at a connection between the pyrolysis chamber and the cavity was closed, and He gas was introduced again at a flow rate of 20 sccm, under a controlled pressure of 80 mTorr. And after stabilization, a mixed monomer of 2-perfluorohexylethyl acrylate and 1,6 hexanediol diacrylate with a mass ratio of 4:1 was introduced into the gasification chamber at a flow rate of 150 μL/min, gasified at a gasification temperature of 90° C., and introduced into the cavity. Pulse plasma discharge was turned on, to carry out plasma-enhanced chemical vapor deposition, with a pulse duty cycle of 10%, at a frequency of 50 Hz, with a discharge power of 150 W, for a reaction time of 1800 seconds.

After the coating was completed, the cavity was filled with compressed air to restore the normal pressure, and the coated silicon wafer, printed circuit board and black ink plate sample were taken out. The silicon wafer was tested for coating thickness and water contact angle at each of points taken from three layers of A, B and C from top to bottom in the bracket, and test results are listed in Table 1. The printed circuit board was tested for 20.5 V acid sweat soaking power-on at each of points taken from three layers of A, B and C from top to bottom in the bracket, and test results are listed in Table 1. The black ink plate sample was tested for the binding force at each of points taken from three layers of A, B and C from top to bottom in the bracket, and test results are listed in Table 1.

### Example 3

Parylene C powder and a 3-aminopropyl triethoxysilane monomer were loaded into their respective feeding areas. A silicon wafer, a printed circuit board and a black ink plate sample were placed on a rotating bracket in a vacuum deposition cavity, followed by rotating the rotating bracket. And then, the cavity was evacuated to 10 mTorr, and introduced with helium gas at a flow rate of 40 sccm, under a pressure stably controlled at 80 mTorr, at a cavity temperature of 30° C.

Plasma continuous discharge was turned on for pretreatment, with a discharge power of 180 W, for a continuous discharge time of 300 seconds, to carry out surface pretreatment for the silicon wafer, the printed circuit board and the black ink plate sample. And then, the discharge was ended when the pretreatment was completed.

Thereafter, the 3-aminopropyl triethoxysilane monomer was introduced into a gasification chamber at a flow rate of 480 μL/min, gasified at a gasification temperature of 90° C., and then, introduced into the cavity. Subsequently, pulse plasma discharge was turned on, to carry out plasma chemical vapor deposition, with a pulse duty cycle of 8%, at a pulse frequency of 50 Hz, with a pulse discharge power of 200 W, for a reaction time of 600 seconds.

The discharge was ended, the monomer and helium feed was turned off, the pressure in the cavity was controlled to 20 mTorr. Then, the parylene C powder was heated in a sublimation chamber to 170° C. and sublimated, entered a pyrolysis chamber and pyrolyzed at a temperature of 690° C., and then introduced into the cavity and deposited, for a deposition time of 4 h. Raw materials that were not deposited were adsorbed through a cold trap to prevent them from entering a vacuum pump.

Then, a valve at a connection between the pyrolysis chamber and the cavity was closed, and He gas was introduced again at a flow rate of 20 sccm, under a controlled pressure of 80 mTorr. And after stabilization, a hydroxyethyl methacrylate monomer was introduced into the gasification chamber at a flow rate of 300 μL/min, gasified at a gasification temperature of 110° C., and introduced into the cavity. Pulse plasma discharge was turned on, to carry out plasma-enhanced chemical vapor deposition, with a pulse duty cycle of 10%, at a frequency of 50 Hz, with a discharge power of 300 W, for a reaction time of 3600 seconds.

After the coating was completed, the cavity was filled with compressed air to restore the normal pressure, and the coated silicon wafer, printed circuit board and black ink plate sample were taken out. The silicon wafer was tested for coating thickness and water contact angle at each of points taken from three layers of A, B and C from top to bottom in the bracket, and test results are listed in Table 1. The printed circuit board was tested for 20.5 V acid sweat soaking power-on at each of points taken from three layers of A, B and C from top to bottom in the bracket, and test results are listed in Table 1. The black ink plate sample was tested for the binding force at each of points taken from three layers of A, B and C from top to bottom in the bracket, and test results are listed in Table 1.

### Comparative Example 1

Parylene C powder was loaded into a feeding area. A silicon wafer, a printed circuit board and a black ink plate sample were placed on a rotating bracket in a vacuum deposition cavity, followed by rotating the rotating bracket. And then, the cavity was evacuated to 10 mTorr, at a cavity temperature of 30° C.

The pressure in the cavity was controlled to 20 mTorr. Then, the parylene C powder was heated in a sublimation chamber to 170° C. and sublimated, entered a pyrolysis chamber and pyrolyzed at a temperature of 690° C., and then introduced into the cavity and deposited, for a deposition time of 4 h. Raw materials that were not deposited were adsorbed through a cold trap to prevent them from entering a vacuum pump.

After the coating was completed, the cavity was filled with compressed air to restore the normal pressure, and the coated silicon wafer, printed circuit board and black ink plate sample were taken out. The silicon wafer was tested for coating thickness and water contact angle at each of points taken from three layers of A, B and C from top to bottom in the bracket, and test results are listed in Table 1. The printed circuit board was tested for 20.5 V acid sweat soaking power-on at each of points taken from three layers of A, B and C from top to bottom in the bracket, and test results are listed in Table 1. The black ink plate sample was tested for the binding force at each of points taken from three layers of A, B and C from top to bottom in the bracket, and test results are listed in Table 1.

### Comparative Example 2

Parylene N powder was loaded into a feeding area. A silicon wafer, a printed circuit board and a black ink plate sample were placed on a rotating bracket in a vacuum deposition cavity, followed by rotating the rotating bracket. And then, the cavity was evacuated to 10 mTorr, at a cavity temperature of 30° C.

The pressure in the cavity was controlled to 20 m Torr. Then, the parylene N powder was heated in a sublimation chamber to 150° C. and sublimated, entered a pyrolysis chamber and pyrolyzed at a temperature of 650° C., and then introduced into the cavity and deposited, for a deposition time of 4 h. Raw materials that were not deposited were adsorbed through a cold trap to prevent them from entering a vacuum pump.

After the coating was completed, the cavity was filled with compressed air to restore the normal pressure, and the coated silicon wafer, printed circuit board and black ink plate sample were taken out. The silicon wafer was tested for coating thickness and water contact angle at each of points taken from three layers of A, B and C from top to bottom in the bracket, and test results are listed in Table 1. The printed circuit board was tested for 20.5 V acid sweat soaking power-on at each of points taken from three layers of A, B and C from top to bottom in the bracket, and test results are listed in Table 1. The black ink plate sample was tested for the binding force at each of points taken from three layers of A, B and C from top to bottom in the bracket, and test results are listed in Table 1.

### Comparative Example 3

Parylene C powder was loaded into a feeding area. A silicon wafer, a printed circuit board and a black ink plate sample were placed on a rotating bracket in a vacuum deposition cavity, followed by rotating the rotating bracket. And then, the cavity was evacuated to 10 mTorr, and introduced with helium gas at a flow rate of 40 sccm, under a pressure stably controlled at 80 mTorr, at a cavity temperature of 30° C.

Plasma continuous discharge was turned on for pretreatment, with a discharge power of 180 W, for a continuous discharge time of 300 seconds, to carry out surface pretreatment for the silicon wafer, the printed circuit board and the black ink plate sample. And then, the discharge was ended, and the helium gas was turned off when the pretreatment was completed. The pressure in the cavity was controlled to 20 mTorr. Then, the parylene C powder was heated in a sublimation chamber to 170° C. and sublimated, entered a pyrolysis chamber and pyrolyzed at a temperature of 690° C., and then introduced into the cavity and deposited, for a deposition time of 4 h. Raw materials that were not deposited were adsorbed through a cold trap to prevent them from entering a vacuum pump.

After the coating was completed, the cavity was filled with compressed air to restore the normal pressure, and the coated silicon wafer, printed circuit board and black ink plate sample were taken out. The silicon wafer was tested for coating thickness and water contact angle at each of points taken from three layers of A, B and C from top to bottom in the bracket, and test results are listed in Table 1. The printed circuit board was tested for 20.5 V acid sweat soaking power-on at each of points taken from three layers of A, B and C from top to bottom in the bracket, and test results are listed in Table 1. The black ink plate sample was tested for the binding force at each of points taken from three layers of A, B and C from top to bottom in the bracket, and test results are listed in Table 1.

TABLE 1
Test results of Examples 1-3 and Comparative Examples 1-3

| | | | Water | 20.5 V acid | Binding |
|---|---|---|---|---|---|
| | | Thick- | contact | sweat soaking | forces of |
| | Coating | nesses | angles | power-on | the black |
| | positions | (nm) | (°) | duration (h) | ink plates |
| Example 1 | A | 6337 | 88 | >100 | 4B |
| | B | 4594 | 89 | >100 | 5B |
| | C | 5767 | 87 | >100 | 5B |
| Example 2 | A | 6799 | 135 | >100 | 5B |
| | B | 6338 | 141 | >100 | 5B |
| | C | 5782 | 138 | >100 | 5B |
| Example 3 | A | 6644 | 13 | >100 | 4B |
| | B | 6406 | 12 | >100 | 5B |
| | C | 5818 | 12 | >100 | 5B |
| Comparative | A | 4925 | 91 | >100 | 0B |
| Example 1 | B | 5813 | 87 | >100 | 0B |
| | C | 4617 | 89 | >100 | 0B |
| Comparative | A | 3163 | 83 | >100 | 0B |
| Example2 | B | 3132 | 86 | >100 | 1B |
| | C | 3584 | 87 | >100 | 1B |
| Comparative | A | 4213 | 89 | >100 | 2B |
| Example 3 | B | 4431 | 88 | >100 | 2B |
| | C | 5011 | 90 | >100 | 1B |

According to the results in Table 1 above, compared with Comparative Examples 1-3, all the 20.5V acid sweat soaking power-on duration in Examples 1-3 is >100 hours, which indicates that although they can maintain excellent acid resistance of the parylene coating, the coatings in Examples 1-3 have more excellent binding forces with the black ink plate. It is shown that that the binding force between the parylene coating and the substrate can be greatly improved by forming a plasma polymeric coating of 3-aminopropyl triethoxysilane between the parylene coating and the substrate. It can be seen according to the results of Examples 2 and 3 that, a hydrophobic or hydrophilic coating can be effectively formed on the parylene coating from plasma of a hydrophobic or hydrophilic monomer, which can greatly expand the further application of the parylene coating.

Although the present disclosure is disclosed as above, the present disclosure is not limited hereto. Various changes and modifications may be made by those skilled in the art without departing from the spirit and scope of this disclosure. Therefore, the scope of protection of the present disclosure shall be subject to the scope limited by the claims.

1. A composite coating, comprising a coating I and a coating II;
wherein, the coating I is a plasma polymeric coating formed by contact of a substrate with plasma containing a monomer α, and the monomer α has a structure represented by formula (1), 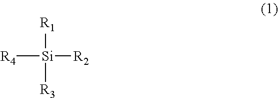
in formula (1), R₁ is a vinyl group or a substituted C₁-C₁₀ alkyl group, a substituent for the substituted C₁-C₁₀ alkyl group comprises at least one selected from a group consisting of halogen atoms, alkenyl groups, alkynyl groups, hydrocarbyloxy groups, amino groups, epoxy groups, acyloxy groups, amide groups, hydroxyl groups and sulfhydryl groups, and R₂, R₃ and R₄ are each independently selected from a group consisting of halogen atoms, C₁-C₁₀ alkoxy groups, substituted C₁-C₁₀ alkoxy groups, C₁-C₁₀ acyloxy groups and substituted C₁-C₁₀ acyloxy groups; and
the coating II is a parylene coating formed by vacuum vapor deposition on the coating I.

2. The composite coating according to claim 1, wherein R₁ is a vinyl group, a glycidyloxypropyl group, an acryloyloxypropyl group, a methacryloyloxypropyl group, a N-(β-aminoethyl)-γ-aminopropyl group, a N-(β-aminoethyl)-γ-aminopropyl-methyl group, a chloropropyl group, a mercaptopropyl group, a hydroxypropyl group or an aminopropyl group, and R₂, R₃ and R₄ are each independently a chlorine atom, a methoxy group, an ethoxy group or a methoxyethoxy group.

3. The composite coating according to claim 2, wherein the monomer α is at least one selected from a group consisting of vinyl trichlorosilane, vinyl trimethoxysilane, vinyl triethoxysilane, vinyl tri(β-methoxyethoxy)silane, γ-glycidyloxypropyl-trimethoxysilane, γ-glycidyloxypropyl-triethoxysilane, 3-(acryloyloxy) propyltrimethoxysilane, γ-methacryloyloxypropyl-trimethoxysilane, γ-methacryloyloxypropyl-triethoxysilane, N-(β-aminoethyl)-γ-aminopropyl-methyl-trimethoxysilane, N-(β-aminoethyl)-γ-aminopropyl-methyl-triethoxysilane, N-(β-aminoethyl)-γ-aminopropyl-trimethoxysilane, N-(β-aminoethyl)-γ-aminopropyl-triethoxysilane, γ-chloropropyl-trimethoxysilane, γ-chloropropyl-triethoxysilane, γ-mercaptopropyl-trimethoxysilane, γ-mercaptopropyl-triethoxysilane, γ-aminopropyl-trimethoxysilane and γ-aminopropyl-triethoxysilane.

4. The composite coating according to claim 3, wherein the monomer α is γ-aminopropyl-triethoxysilane.

5. The composite coating according to claim 1, further comprising a coating III, which is a hydrophobic or hydrophilic plasma polymeric coating formed by contact of the coating II with plasma containing a monomer β.

6. The composite coating according to claim 5, wherein the monomer β has a structure represented by formula (2), 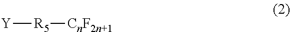
in formula (2), R₅ is a linking bond, a C₁-C₄ alkylidene group or a halogenated C₁-C₄ alkylidene group, Y is a halogen atom, a hydrogen atom, a hydroxyl group, or a structure represented by formula (3) or (4), and n is an integer from 1 to 12, 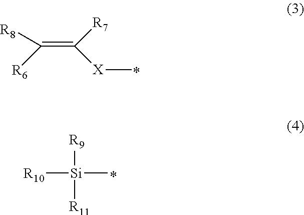
in formula (3), R₆, R₇ and R₈ are each independently selected from a group consisting of a hydrogen atom, halogen atoms, C₁-C₄ alkyl groups or halogenated C₁-C₄ alkyl groups, and X is a linking bond or an ester bond, and
in formula (4), R₉, R₁₀ and R₁₁ are each independently selected from a group consisting of a hydrogen atom, C₁-C₄ alkyl groups, halogenated C₁-C₄ alkyl groups, C₁-C₄ alkoxy groups and halogenated C₁-C₄ alkoxy groups.

7. The composite coating according to claim 6, wherein the monomer β has a structure represented by formula (5), 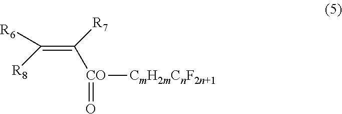
in formula (5), m is an integer from 0 to 4.

8. The composite coating according to claim 7, wherein R₆, R₇ and R₈ are each independently selected from a group consisting of a hydrogen atom and a methyl group, m is an integer from 0 to 2, and n is an integer from 1 to 10.

9. The composite coating according to claim 8, wherein the monomer β is 2-perfluorohexylethyl acrylate.

10. The composite coating according to claim 5, wherein the monomer β has a structure represented by formula (6), 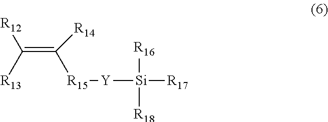
in formula (6), R₁₂, R₁₃ and R₁₄ are each independently selected from a group consisting of a hydrogen atom, halogen atoms, C₁-C₄ alkyl groups and halogenated C₁-C₄ alkyl groups, R₁₅ is a linking bond, a C₁-C₄ alkylidene group or a halogenated C₁-C₄ alkylidene group, R₁₆, R₁₇ and R₁₈ are each independently selected from a group consisting of a hydrogen atom, C₁-C₄ alkyl groups, halogenated C₁-C₄ alkyl groups, C₁-C₄ alkoxy groups and halogenated C₁-C₄ alkoxy groups, and Y is a linking bond or an oxygen atom.

11. The composite coating according to claim 5, wherein the monomer β has a structure represented by formula (7), 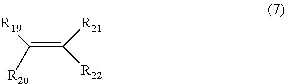
in formula (7), R₁₉ is a C₁-C₄ amide group, a substituted C₁-C₄ alkoxy group, a substituted C₁-C₄ alkyl group or a substituted C₁-C₄ ester group, and R₂₀, R₂₁ and R₂₂ are each independently selected from a group consisting of a hydrogen atom, C₁-C₄ amide groups, substituted C₁-C₄ alkoxy groups, substituted C₁-C₄ alkyl groups, substituted C₁-C₄ ester groups and C₁-C₄ hydrocarbyl groups; and
a substituent for each of the substituted C₁-C₄ alkoxy groups, the substituted C₁-C₄ alkyl groups and the substituted C₁-C₄ ester groups is a hydroxyl group, a carboxyl group or an amino group.

12. The composite coating according to claim 11, wherein R₁₉ is a C₁-C₄ hydroxyalkyl ester group, and R₂₀, R₂₁ and R₂₂ are each independently selected from a group consisting of a hydrogen atom and a methyl group.

13. The composite coating according to claim 11, wherein the monomer β is at least one selected from a group consisting of acrylic acid, methacrylic acid, 3,3-dimethacrylic acid, hydroxyethyl acrylate, hydroxypropyl acrylate, hydroxyethyl methacrylate, 1-buten-3-ol, 1,4-butanediol, 3-penten-2-ol, cis-3-hexen-1-ol, methallyl alcohol, 2,7-octadien-1-ol, N-tert-butylacrylamide, glycerol dimethacrylate, N,N-diethylaminoethyl acrylate, dimethylaminoethyl methacrylate and N, N-dimethylacrylamide.

14. The composite coating according to claim 5, wherein the coating III is a hydrophobic or hydrophilic plasma polymeric coating formed by contact of the coating II with plasma containing the monomer β and a monomer δ, and the monomer δ has a structure represented by formula (8), 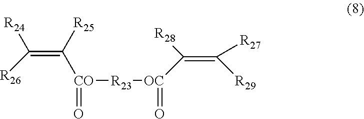
in formula (8), R₂₄, R₂₅, R₂₆, R₂₇, R₂₈ and R₂₉ are each independently selected from a group consisting of a hydrogen atom, C₁-C₁₀ alkyl groups or halogenated C₁-C₁₀ alkyl groups, and R₂₃ is a linker.

15. The composite coating according to claim 14, wherein the monomer δ has a structure represented by formula (9), 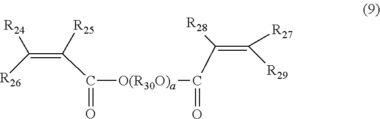
in formula (9), R₃₀ is a C₂-C₁₀ alkylidene group or a halogenated C₂-C₁₀ alkylidene group, and a is an integer from 1 to 10.

16. The composite coating according to claim 15, wherein R₂₄, R₂₅, R₂₆, R₂₇, R₂₈ and R₂₉ are each independently selected from a group consisting of a hydrogen atom and a methyl group, and a is an integer from 1 to 4.

17. The composite coating according to claim 16, wherein the monomer δ is at least one selected from a group consisting of 1,4-butanediol dimethacrylate, 1,6-hexanediol dimethacrylate, ethylene glycol dimethacrylate, diethylene glycol dimethacrylate, triethylene glycol dimethacrylate, tetraethylene glycol dimethacrylate, 1,3-butanediol dimethacrylate and neopentyl glycol dimethacrylate.

18. A method for preparing the composite coating according to any one of claim 1, comprising the following steps:
providing a substrate and placing the substrate in a vacuum deposition cavity, introducing the monomer α in gaseous form into the vacuum deposition cavity, and performing plasma discharge, to form the coating I by plasma polymerization on a surface of the substrate; and
introducing sublimated and pyrolyzed parylene powder into the vacuum deposition cavity, to form the coating II on the coating I.

19. The method according to claim 18, further comprising introducing the monomer β in gaseous form, or introducing the monomer β and the monomer δ in gaseous form, into the vacuum deposition cavity, and performing plasma discharge, to form the coating III on a surface of the coating II by plasma polymerization.

20. A device, having at least a part of a surface thereof coated by the composite coating according to claim 1.
